(19) United States
(12) Patent Application Publication
(10) Pub. No.: US 2009/0235179 A1
(43) Pub. Date: Sep. 17, 2009

(54) SYSTEM AND METHOD FOR REMOTE THIN-CLIENT BASED ALTERATION OF DOCUMENT PROCESSING DEVICE USER INTERFACE VIEWS

(76) Inventors: Harpreet Singh, Orange, CA (US); Brenda Daos, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/047,790

(22) Filed: Mar. 13, 2008

(51) Int. Cl. G06F 3/048

(52) U.S. Cl. 715/744

(57) ABSTRACT

The subject application is directed to a system and method for remote, thin-client based alteration of document processing device user interface views. Data is first received into a thin-client interface of pre-set user interface views associated with document processing devices, and preview images of each pre-set interface are generated on the thin-client. Interface selection data, indicative of a selected pre-set user interface from the plurality of interfaces, is then received via the thin-client interface. Customization data, corresponding to modification of the selected pre-set user interface, is then received via the thin-client interface. An updated preview image of a modified user interface rendered in accordance with the received customization data is then generated, and custom interface data of the modified interface is communicated to an associated document processing device so as to generate the modified user interface on an associated display panel.

### BACKGROUND OF THE INVENTION

The subject application is directed generally to customizable user interfaces on document processing devices. The application is particularly suited for remote customization of document processing device user interfaces by administrators working remotely via a thin-client interface.

Document processing devices include printers, copiers, facsimile machines, scanners, and electronic mail devices. More recently, two or more of these functions are combined in a device referred to as a multifunction peripheral or MFP.

Given the size, cost, and maintenance requirements of sophisticated document processing devices, they are typically shared among a plurality of individuals in an office environment. Larger enterprises include many such devices, which need to be maintained, customized, or updated by system administrators.

The flexibility and power of modem data document processing devices have lead to the utilization of graphical user interface controls to render control of complex functions more intuitive and understandable. Such controls are frequently realized on a touchscreen interface associated with a device, such as an MFP.

Touchscreen interfaces provide a template that is usable to provide a customized look that is aligned with an image associated with an enterprise. By way of example, shareable devices at a copy center may be advantageously adapted with customized indicia, logos, advertising, or corporate color schemes. However, modification or updating of many devices is often not possible, given that such schemes are fixed by a device manufacturer while being built. Even if possible, modification of many devices would be a complex and time-consuming process.

### SUMMARY OF THE INVENTION

In accordance with one embodiment of the subject application, there is provided a system and method for customizable user interfaces on document processing devices.

Further in accordance with one embodiment of the subject application, there is provided a system and method for remote customization of document processing device user interfaces by administrators working remotely via a thin-client interface.

Still further in accordance with one embodiment of the subject application, there is provided a system for remote, thin-client based alteration of document processing device user interface views. The system comprises means adapted for receiving, into a thin-client interface, data corresponding to a plurality of pre-set user interface views associated with document processing devices and means adapted for generating preview images associated with each of the plurality of pre-set user interface images on the thin-client interface. The system also comprises means adapted for receiving interface selection data via the thin-client interface, which selection data is indicative of a selected pre-set user interface from the plurality thereof, and means adapted for receiving, via the thin-client interface, customization data corresponding to modification of the selected pre-set user interface. The system further includes updating means adapted for generating an updated preview image of a modified user interface rendered in accordance with received customization data and output means adapted for communicating custom interface data, corresponding to the modified user interface, to at least one associated document processing device so as to generate the modified user interface on a display panel associated therewith.

In one embodiment of the subject application, the system also comprises means adapted for generating, on the thin-client interface, images corresponding to a plurality of selectable options associated with the selected user interface and means adapted for receiving option selection data corresponding to at least one of the selectable options. In such an embodiment, the customization data includes data corresponding to received option selection data.

In another embodiment of the subject application, the system also includes means adapted for generating, on the thin-client interface, device information data corresponding to at least one document processing device compatible with the custom interface data and means adapted for receiving, via the thin-client interface, device selection data corresponding to selected document processing devices chosen from the device information data. In this embodiment, the output means includes means adapted for communicating the custom interface data in accordance with received device selection data.

In a further embodiment of the subject application, the pre-set user interface views include a plurality of available interface color schemes.

In yet another embodiment of the subject application, the customization data includes graphical element data corresponding to at least one graphical element selected for display on a user interface.

Still further in accordance with one embodiment of the subject application, there is provided a method for remote, thin-client based alteration of document processing device user interface views in accordance with the system as set forth above.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for remote, thin-client based alteration of document processing device user interface views according to one embodiment of the subject application;

FIG. 2 is a block diagram illustrating device hardware for use in the system for remote, thin-client based alteration of document processing device user interface views according to one embodiment of the subject application;

FIG. 3 is a functional diagram illustrating the device for use in the system for remote, thin-client based alteration of document processing device user interface views according to one embodiment of the subject application;

FIG. 4 is a block diagram illustrating controller hardware for use in the system for remote, thin-client based alteration of document processing device user interface views according to one embodiment of the subject application;

FIG. 5 is a functional diagram illustrating the controller for use in the system for remote, thin-client based alteration of document processing device user interface views according to one embodiment of the subject application;

FIG. 6 is a block diagram illustrating an administrative workstation for use in the system for remote, thin-client based alteration of document processing device user interface views according to one embodiment of the subject application;

FIG. 7 is a flowchart illustrating a method for remote, thin-client based alteration of document processing device user interface views according to one embodiment of the subject application;

FIG. 8 is a flowchart illustrating a method for remote, thin-client based alteration of document processing device user interface views according to one embodiment of the subject application; and

FIG. 9 is an example user interface for use in the system and method for remote, thin-client based alteration of document processing device user interface views according to one embodiment of the subject application.

### DETAILED DESCRIPTION OF THE PREFERRED EMBODIMENT

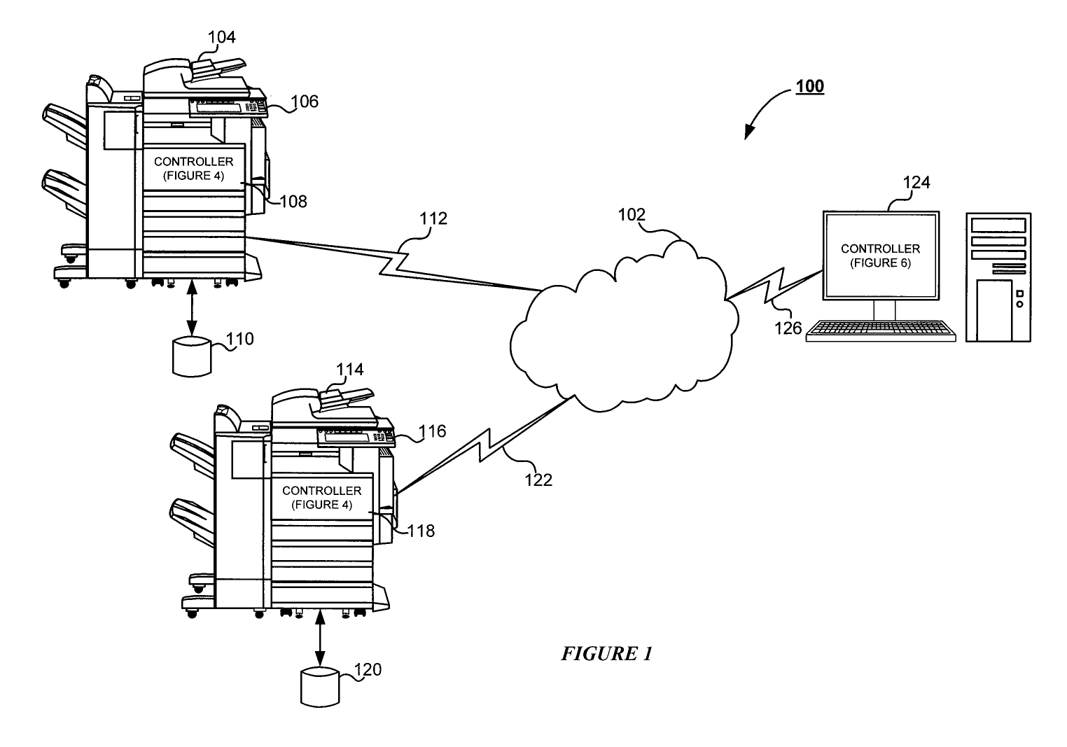

The subject application is directed to a system and method for customizable user interfaces on document processing devices. In particular, the subject application is directed to a system and method for remote, thin-client based alteration of document processing device user interface views. More particularly, the subject application is directed to a system and method that allows an administrator to remotely alter document processing device user interface views via a thin-client interface. It will become apparent to those skilled in the art that the system and method described herein are suitably adapted to a plurality of varying electronic fields employing remote access including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for remote, thin-client based alteration of document processing device user interface views in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a plurality of document processing devices 104 and 114, depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 and 114 are suitably adapted to provide remote document processing services to external or network devices. Preferably, the document processing devices 104 and 114 include hardware, software, and any suitable combination thereof, configured to interact with an associated user, a networked device, or the like.

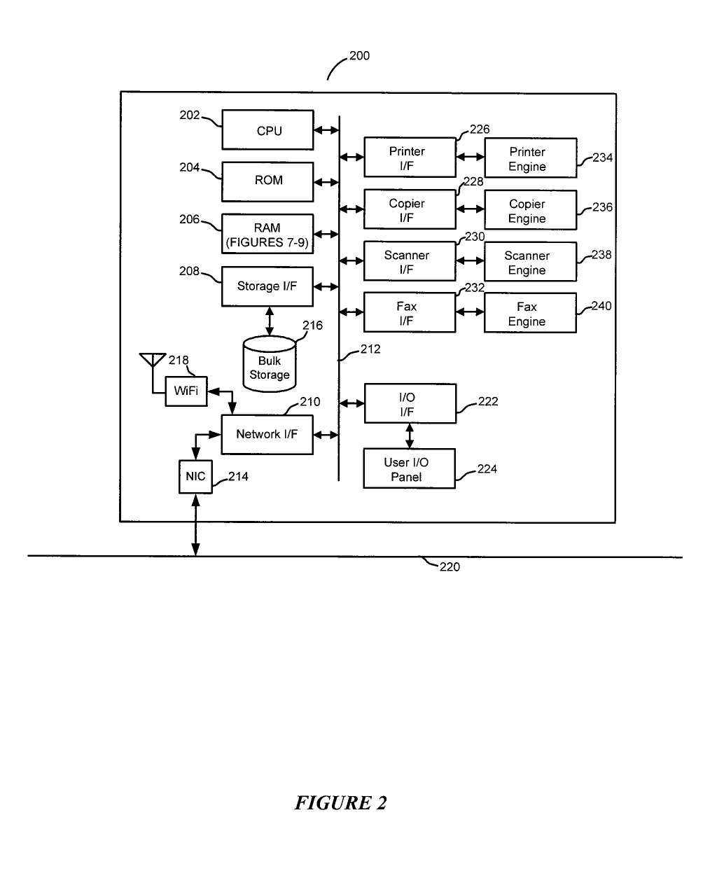

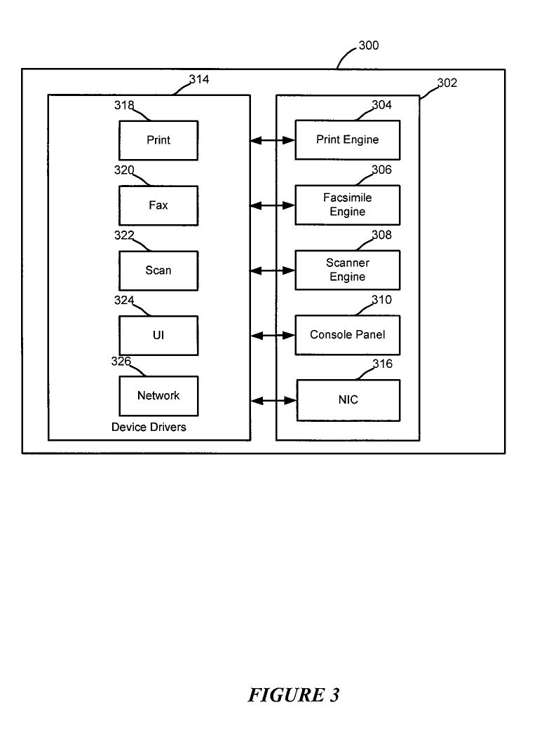

According to one embodiment of the subject application, the document processing devices 104 and 114 are suitably equipped to receive a plurality of portable storage media including, without limitation, Firewire drive, USB drive, SD, MMC, XD, Compact Flash, Memory Stick, and the like. In the preferred embodiment of the subject application, the document processing devices 104 and 114 further include associated user interfaces 106 and 116, such as touch-screens, LCD displays, touch-panels, alpha-numeric keypads, or the like, via which an associated user is able to interact directly with the corresponding document processing device 104 or 114. In accordance with the preferred embodiment of the subject application, the user interfaces 106 and 116 are advantageously used to communicate information to the associated user and receive selections from the associated user. The skilled artisan will appreciate that the user interfaces 106 and 116 comprise various components suitably adapted to present data to the associated user, as are known in the art. In accordance with one embodiment of the subject application, the user interfaces 106 and 116 comprise a display suitably adapted to display one or more graphical elements, text data, images, or the like to an associated user; receive input from the associated user; and communicate the same to a backend component, such as the controllers 108 and 118, as explained in greater detail below. Preferably, the document processing devices 104 and 114 are communicatively coupled to the computer network 102 via suitable communications links 112 and 122. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104 and 114 will better be understood in conjunction with the block diagrams illustrated in FIGS. 2 and 3, as explained in greater detail below.

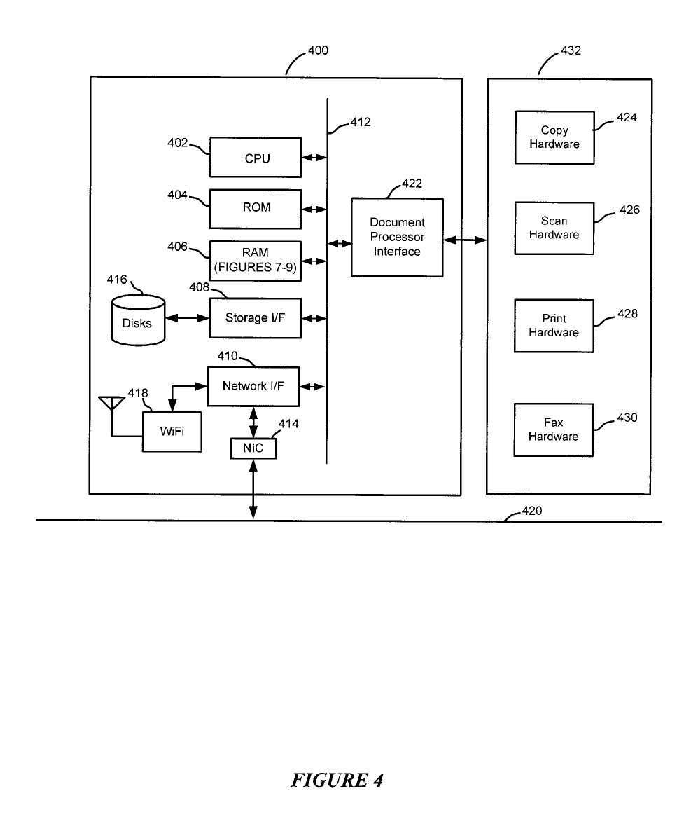

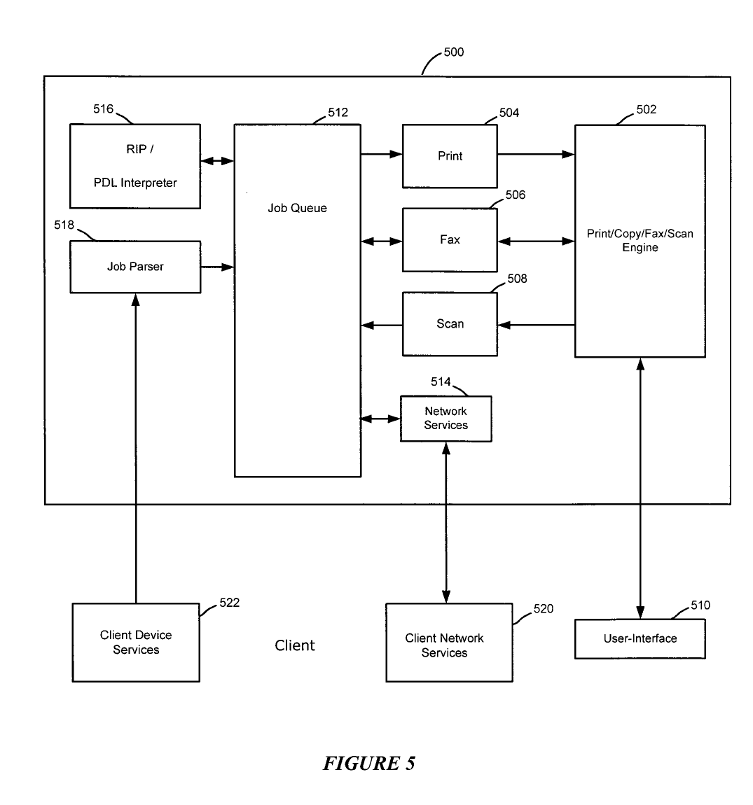

In accordance with one embodiment of the subject application, the document processing devices 104 and 114 further incorporate backend components, designated as the controllers 108 and 118, suitably adapted to facilitate the operations of the document processing devices 104 and 114, as will be understood by those skilled in the art. Preferably, the controllers 108 and 118 are embodied as hardware, software, or any suitable combination thereof configured to control the operations of the associated document processing devices 104 and 114, facilitate the display of images via the user interfaces 106 and 116, direct the manipulation of electronic image data, and the like. For purposes of explanation, the controllers 108 and 118 are used to refer to any of the myriad components associated with the document processing devices 104 and 114, including hardware, software, or combinations thereof functioning to perform, cause to be performed, control, or otherwise direct the methodologies described hereinafter. It will be understood by those skilled in the art that the methodologies described with respect to the controllers 108 and 118 are capable of being performed by any general purpose computing system known in the art, and, thus, the controllers 108 and 118 are representative of such a general computing device and are intended as such when used hereinafter. Furthermore, the use of the controllers 108 and 118 hereinafter are for the example embodiment only, and other embodiments, which will be apparent to one skilled in the art, are capable of employing the system and method for remote, thin-client based alteration of document processing device user interface views of the subject application. The functioning of the controllers 108 and 118 will better be understood in conjunction with the block diagrams illustrated in FIGS. 4 and 5, explained in greater detail below.

Communicatively coupled to the document processing devices 104 and 114 are data storage devices 110 and 120, respectively. In accordance with the preferred embodiment of the subject application, the data storage devices 110 and 120 are any mass storage device known in the art including, for example and without limitation, magnetic storage drives, a hard disk drive, optical storage devices, flash memory devices, or any suitable combination thereof. In the preferred embodiment, the data storage devices 110 and 120 are suitably adapted to store document data, image data, electronic database data, or the like. It will be appreciated by those skilled in the art that, while illustrated in FIG. 1 as being separate components of the system 100, the data storage devices 110 and 120 are capable of being implemented as internal storage components of the document processing devices 104 and 114, components of the controllers 108 and 118, or the like, such as, for example and without limitation, an internal hard disk drive or the like.

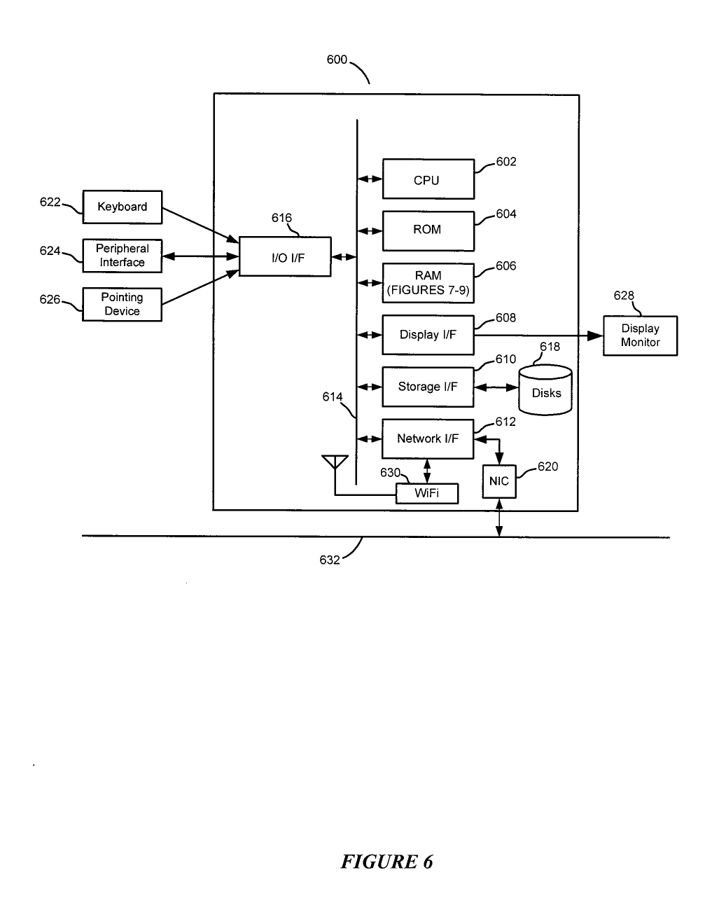

The system 100 illustrated in FIG. 1 further depicts an administrative workstation or device 124 in data communication with the computer network 102 via a communications link 126. It will be appreciated by those skilled in the art that the administrative workstation 124 is shown in FIG. 1 as a computer workstation for illustration purposes only. As will be understood by those skilled in the art, the administrative workstation 124 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 126 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the administrative workstation 124 is suitably adapted to generate and transmit electronic documents, document processing instructions, user interface modifications, upgrades, updates, personalization data, or the like to the document processing devices 104 and 114, or any other similar device coupled to the computer network 102. The functioning of the administrative workstation 124 will better be understood in conjunction with the block diagram illustrated in FIG. 6, explained in greater detail below.

Turning now to FIG. 2, illustrated is a representative architecture of a suitable device 200, shown in FIG. 1 as the document processing devices 104 and 114, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions, such as BIOS functions, system functions, system configuration data, and other routines or data used for operation of the device 200.

Also included in the device 200 is random access memory 206 suitably formed of dynamic random access memory, static random access memory, or any other suitable, addressable memory system. Random access memory 206 provides a storage area for data instructions associated with applications and data handling accomplished by the processor 202.

A storage interface 208 suitably provides a mechanism for volatile, bulk, or long term storage of data associated with the device 200. The storage interface 208 suitably uses bulk storage, such as any suitable addressable or serial storage such as a disk, optical, tape drive, and the like, as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Suitable executable instructions on the device 200 facilitate communication with a plurality of external devices such as workstations, document processing devices, other servers, or the like. While, during operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104 and 114, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and, in turn, image data corresponding thereto. A user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via print driver 318, facsimile communication via facsimile driver 320, scanning via scan driver 322, and user interface functions via user interface driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controllers 108 and 118, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable, addressable, and writable memory system. Random access memory 406 provides a storage area for data instructions associated with applications and data handling accomplished by processor 402.

A storage interface 408 suitably provides a mechanism for non-volatile, bulk, or long term storage of data associated with the controller 400. The storage interface 408 suitably uses bulk storage such as any suitable addressable or serial storage, such as a disk, optical, tape drive and the like, as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, token ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices capable of one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter, or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown in FIG. 1 as the administrative workstation 124, for use in connection with the subject system. A suitable workstation includes a processor unit 602 that is advantageously placed in data communication with read only memory 604, suitably non-volatile read only memory, volatile read only memory, or a combination thereof, random access memory 606; display interface 608; storage interface 610; and network interface 612. In a preferred embodiment, interface to the foregoing modules is suitably accomplished via a bus 614.

The read only memory 604 suitably includes firmware, such as static data or fixed instructions such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device, as will be appreciated by one of ordinary skill in the art.

The storage interface 610 suitably provides a mechanism for non-volatile, bulk, or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624 such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices such as a mouse, light pen, touch screen, or the like.

In operation, data is received into a thin-client interface corresponding to a plurality of pre-set user interface views associated with document processing devices. Preview images associated with each of the plurality of pre-set user interface images are then generated on the thin-client interface. Interface selection data is then received via the thin-client interface, with the data indicative of a selected pre-set user interface from the plurality of interfaces. Customization data is then received via the thin-client interface corresponding to modification of the selected pre-set user interface. An updated preview image of a modified user interface, rendered in accordance with the received customization data, is then generated. Custom interface data corresponding to the modified user interface is then communicated to at least one associated document processing device so as to generate the modified user interface on an associated display panel.

In accordance with one example embodiment of the subject application, pre-set user interface view data is received into a thin-client interface corresponding to a plurality of user interface views associated with the document processing devices 104 and 114. Preferably, the thin-client interface is resident on the administrative workstation 124. The skilled artisan will appreciate that the thin-client interface is representative of, for example and without limitation, a web-based portal, a web-browser, an application, or the like resident on the administrative workstation 124 via which an administrative user is capable of accessing such views, communicating with the document processing devices 104 and 114, and the like. Preview images of each pre-set user interface are then generated on the thin-client associated with the administrative workstation 124. That is, the administrative user associated with the administrative workstation 124 is presented, via the thin-client interface, with images corresponding to the user interface displayed on the user interfaces 106 and 116 of the associated document processing devices 104 and 114, respectively.

Interface selection data is then received from the administrative user via the thin-client interface of the administrative workstation 124. Preferably, the administrative user selects one of the displayed user interface preview images for further modifications or as the user interface to be implemented on a given document processing device 104 and/or 114. Following selection of the desired user interface, images are generated on the thin-client interface of the administrative workstation 124 corresponding to selectable options associated with the selected user interface. That is, the administrative user is presented with options corresponding to colors, icons, graphics, menus, and the like that are capable of being added to the selected user interface, modified with respect to the user interface, or the like. Option selection data is then received from the administrative user corresponding to those options or modifications made to the selected user interface. The option selection data is then added to customization data, which includes the selected user interface, desired colors, animations, graphical elements, and the like.

The received customization data corresponding to the modification of the selected pre-set user interface is then used by the administrative workstation 124 to generate, via the thin-client interface, an updated preview image of the modified user interface rendered in accordance with the customization data. Device information data is then generated on the thin-client interface of the administrative workstation 124 corresponding to those document processing devices 104 and 114 on the computer network 102 that are compatible with the custom interface data, i.e. the selected pre-set user interface. Device selection data is then received from the administrative user via the thin-client interface corresponding to at least one document processing device 104 or 114 displayed in the device information data to receive the custom interface data.

The administrative user is then prompted, via the thin-client interface of the administrative workstation 124, to confirm or cancel the modifications. Upon confirmation by the administrative user, a determination is made as to whether the customization data is to be delivered via electronic communication. When electronic communication is selected by the administrative user, the custom interface data is communicated to the selected document processing devices 104 and/or 114, as set forth in the device selection data, via the computer network 102. Thereafter, the modified user interface is generated on the touch panel of the user interface 106 or 116 associated with the selected document processing device 104 or 114. When electronic communication is not selected by the administrative user, the user is prompted, via the thin-client interface, to select a storage location for the custom interface data. It will be appreciated by those skilled in the art that such storage locations include, for example and without limitation, a portable storage device, e.g. a USB drive, flash memory, optical memory, portable hard disk drive, etc., a storage device (not shown) coupled to the computer network 102, or the like. Storage location data is then received via the thin-client interface, and the customization data is stored at the selected storage location in accordance with the received storage location data.

The customization data is then transferred from the storage location to the selected document processing device 104 or 114. Thereafter, a modified user interface is generated on the touch panel display associated with the user interface 106 or 116 corresponding to the document processing device 104 or 114 to which the customization data was transferred. For example, when the storage location specified by the user corresponds to a portable data storage device, the administrative user physically installs the portable storage device at a desired document processing device 104 or 114. Modifications to the touch panel display of the associated user interface 106 or 116 are then made in accordance with the customization data stored on the portable storage device.

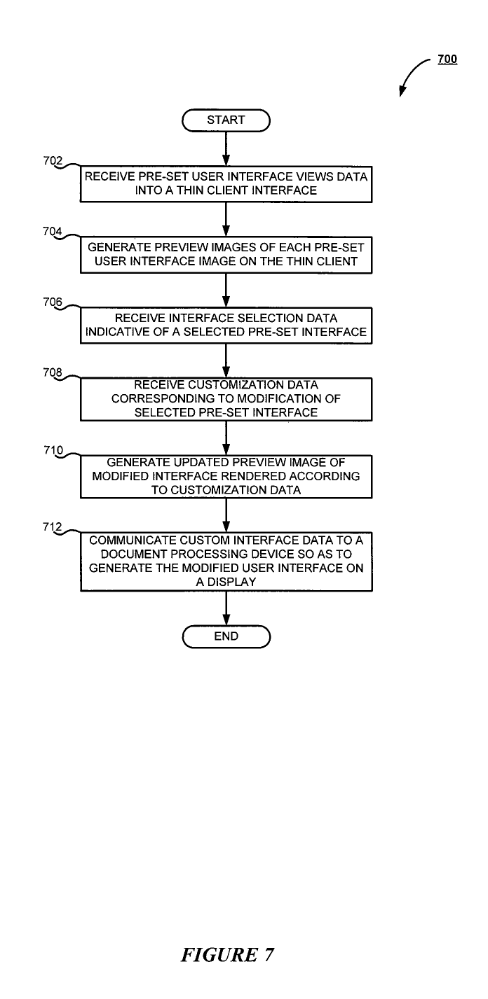

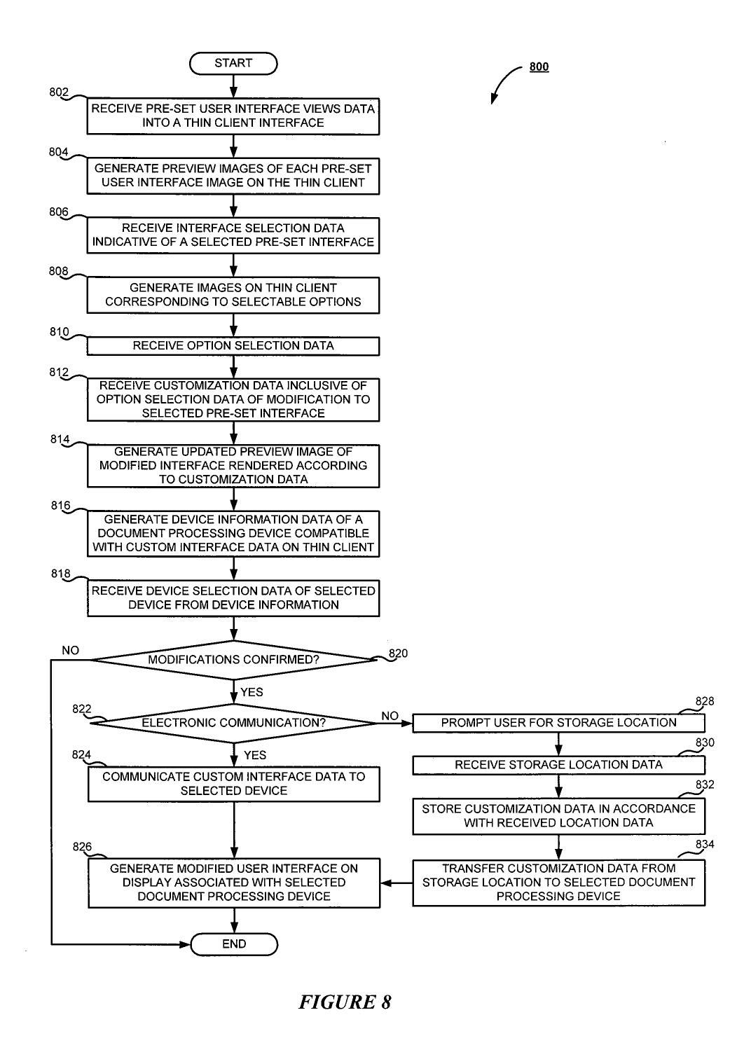

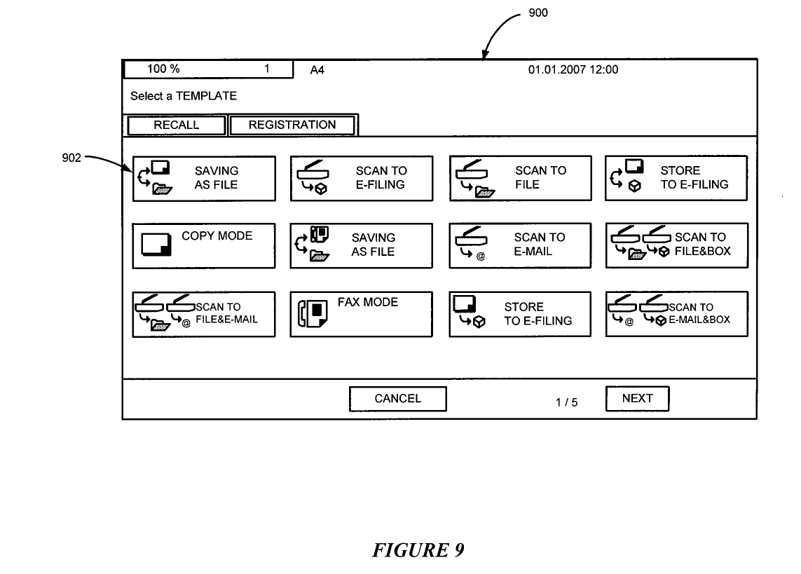

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8, as well as the example interface illustrated in FIG. 9. Turning now to FIG. 7, there is shown a flowchart 700 illustrating a method for remote, thin-client based alteration of document processing device user interface views in accordance with one embodiment of the subject application. Beginning at step 702, pre-set user interface view data is received into a thin-client interface corresponding to a plurality of pre-set user interface views associated with a plurality of document processing devices 104 and 114. In accordance with one embodiment of the subject application, the thin-client interface is displayed on the administrative workstation 124 via which an associated administrative user is able to interact with the thin-client interface.

Preview images are then generated, at step 704, of each of the pre-set user interface views on the thin-client interface associated with the administrative workstation 124. At step 706, interface selection data, indicative of a selected pre-set user interface from among those preview images, is then received via the thin-client interface from the administrative user. Customization data, corresponding to modifications of the selected pre-set user interface, is then received at step 708 from the administrative user via the thin-client interface. At step 710, an updated preview image of the modified interface, rendered in accordance with the customization data, is generated via the thin-client interface. The custom interface data is then communicated at step 712 to a document processing device 104 or 114 so as to generate the modified user interface on a touch panel display of the user interface 106 or 116 associated therewith.

Referring now to FIG. 8, there is shown a flowchart 800 illustrating a method for remote, thin-client based alteration of document processing device user interface views in accordance with one embodiment of the subject application. The methodology of FIG. 8 begins at step 802, whereupon pre-set user interface view data is received into a thin-client interface on the administrative workstation 124, with the view data corresponding to various user interface views of the document processing devices 104 and 114. Suitable thin-client interfaces include, for example and without limitation, web-based portals, web-browsers, software applications, device drivers, and the like. In accordance with one embodiment of the subject application, the thin-client interface resident on the administrative workstation 124 enables an administrative user to access, communicate, modify, or otherwise interact with the document processing devices 104 and 114. It will be understood by those skilled in the art that, while reference is made herein to the thin-client interface resident on the administrative workstation 124, the subject application is capable of implementing the thin-client interface on myriad other suitable devices including, for example and without limitation, the user interfaces 106 and 116 associated with the document processing devices 104 and 114 and other suitable computing devices known in the art.

Preview images of each pre-set user interface are then generated on the thin-client associated with the administrative workstation 124 at step 804. It will be understood by those skilled in the art that the preview images correspond to graphical user interfaces displayed on the user interfaces 106 and 116 of the associated document processing devices 104 and 114. The skilled artisan will appreciate that the preview images of user interface views displayed via the thin-client interface include various color schemes, icons, graphical elements, animations, and the like distinguishing one user interface from another. At step 806, interface selection data indicative of a selected pre-set user interface is received from the administrative user via the thin-client interface of the administrative workstation 124. According to one embodiment of the subject application, the administrative user selects one of the user interface views displayed via the thin-client interface for implementation on a selected document processing device 104 or 114 for modification or the like.

At step 808, images are generated on the thin-client interface of the administrative workstation 124 corresponding to selectable options associated with the selected user interface view. In accordance with one embodiment of the subject application, the administrative user is presented with selectable options, via the thin-client interface, regarding color schemes, graphical elements, menu orientations, and the like that are capable of being modified. FIG. 9 illustrates a preview image of a user interface view 900 in accordance with one embodiment of the subject application. As shown in FIG. 9, the user interface view 900 includes a plurality of graphical elements 902, each of which are capable of being modified in accordance with the subject application. Thus, the skilled artisan will appreciate that modifications, such as changing the color of each element 902, modifying the background, or the like, correspond to suitable option selection data, which is received from the administrative user at step 810.

At step 812, customization data, inclusive of option selection data, is received from the administrative user corresponding to the modifications to the selected pre-set user interface. The administrative workstation 124, via the thin-client interface, then generates, at step 814, an updated preview image of the modified user interface rendered in accordance with the customization data. Thus, the skilled artisan will appreciate that a preview image corresponding to a pre-set user interface is generated on the thin-client incorporating the customization data, i.e. modifications, and selected options.

Device information data is then generated on the thin-client interface of the administrative workstation 124 at step 816. In accordance with one embodiment of the subject application, the device information data is representative of those document processing devices 104 and 114 on the computer network 102 that are compatible with the custom interface data, i.e. able to implement the selected pre-set user interface. At step 818, device selection data is received from the administrative user via the thin-client interface corresponding to one or more document processing devices 104 or 114 set forth in the device information data. According to one embodiment of the subject application, the device information data is displayed to the administrative user via the thin-client interface of the administrative workstation 124. For example and without limitation, the device information data is displayed as a list of devices capable of implementing the modified user interface. From this display, the user selects one or more devices, e.g. the document processing device 104 or 114, to receive the custom interface data.

A determination is then made at step 820 as to whether the administrative user has confirmed the modifications to be made to the pre-set user interface; that is, whether the administrative user, via the thin-client interface of the administrative workstation 124, has confirmed the application of the customization data to the selected user interface. When the modifications are not confirmed by the administrative user or when the user cancels the operations, the methodology illustrated in FIG. 8 terminates following step 820. Upon a determination at step 820 that the administrative user has confirmed the modifications, flow proceeds to step 822. At step 822, a determination is made as to whether the customization data is to be delivered via an electronic communication to the selected document processing device 104 or 114. In accordance with one embodiment of the subject application, the administrative user is prompted, via the thin-client interface, to designate the delivery means, electronic transmission to the selected device, or storage of the customization data for subsequent loading.

Upon a determination at step 822 that electronic communication has been selected by the administrative user, flow proceeds to step 824, whereupon the custom interface data is communicated to the document processing devices 104 and/or 114 set forth in the device selection data. It will be understood by those skilled in the art that such communication includes, for example and without limitation, file transfer via the computer network 102, electronic mail communication from the administrative workstation 124 to the selected document processing device 104 and/or 114, and the like. Flow then progresses to step 826, whereupon the modified user interface is generated on the touch panel of the user interface 106 or 116 associated with the selected document processing device 104 or 114 in accordance with the customized interface data.

Upon a determination at step 822 that electronic communication is not selected, flow proceeds to step 828, whereupon the administrative user is prompted, via the thin-client interface, to select a storage location for the custom interface data. It will be appreciated by those skilled in the art that such storage locations include, for example and without limitation, a portable storage device, e.g. a USB drive, flash memory, optical memory, portable hard disk drive, etc.; a storage device (not shown) coupled to the computer network 102; or the like. At step 830, storage location data is then received via the thin-client interface. The customization data is then stored at the selected storage location in accordance with the received storage location data at step 832. At step 834, the customization data is transferred to the selected document processing device 104 and/or 114. Operations then proceed to step 826, whereupon the modified user interface is generated on a display associated with the selected document processing device 104 and/or 114 based upon the transferred customization data. It will be understood by those skilled in the art that the administrative user, when using a portable storage device, transfers the customization data to the selected document processing device 104 and/or 114 via the physical installation of the portable storage device at the desired document processing device 104 or 114, resulting in the modifications to the touch panel display of the associated user interface 106 or 116 in accordance with the customization data stored on the portable storage device.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program: for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for remote, thin-client based alteration of document processing device user interface views comprising:
means adapted for receiving, into a thin-client interface, data corresponding to a plurality of pre-set user interface views associated with document processing devices;
means adapted for generating preview images associated with each of the plurality of pre-set user interface images on the thin-client interface;
means adapted for receiving interface selection data via the thin-client interface, which selection data is indicative of a selected pre-set user interface from the plurality thereof;
means adapted for receiving, via the thin-client interface, customization data corresponding to modification of the selected pre-set user interface;
updating means adapted for generating an updated preview image of a modified user interface rendered in accordance with received customization data; and
output means adapted for communicating custom interface data, corresponding to the modified user interface, to at least one associated document processing device so as to generate the modified user interface on a display panel associated therewith.

2. The system of claim 1, further comprising:
means adapted for generating images on the thin-client interface corresponding to a plurality of selectable options associated with the selected user interface; and
means adapted for receiving option selection data corresponding to at least one of the selectable options;
wherein the customization data includes data corresponding to received option selection data.

3. The system of claim 2, further comprising:
means adapted for generating, on the thin-client interface, device information data corresponding to at least one document processing device compatible with the custom interface data; and
means adapted for receiving, via the thin-client interface, device selection data corresponding to selected document processing devices chosen from the device information data;
wherein the output means includes means adapted for communicating the custom interface data in accordance with received device selection data.

4. The system of claim 1, wherein the pre-set user interface views include a plurality of available interface color schemes.

5. The system of claim 1, wherein the customization data includes graphical element data corresponding to at least one graphical element selected for display on a user interface.

6. A method for remote, thin-client based alteration of document processing device user interface views comprising the steps of:
receiving, into a thin-client interface, data corresponding to a plurality of pre-set user interface views associated with document processing devices;
generating preview images associated with each of the plurality of pre-set user interface images on the thin-client interface;
receiving interface selection data via the thin-client interface, which selection data is indicative of a selected pre-set user interface from the plurality thereof;
receiving, via the thin-client interface, customization data corresponding to modification of the selected pre-set user interface;
generating an updated preview image of a modified user interface rendered in accordance with received customization data; and
communicating custom interface data, corresponding to the modified user interface, to at least one associated document processing device so as to generate the modified user interface on a display panel associated therewith.

7. The method of claim 6, further comprising the steps of:
generating images on the thin-client interface corresponding to a plurality of selectable options associated with the selected user interface; and
receiving option selection data corresponding to at least one of the selectable options;
wherein the customization data includes data corresponding to received option selection data.

8. The method of claim 7, further comprising the steps of:
generating, on the thin-client interface, device information data corresponding to at least one document processing device compatible with the custom interface data; and
receiving, via the thin-client interface, device selection data corresponding to selected document processing devices chosen from the device information data;
wherein the custom interface data is communicated in accordance with received device selection data.

9. The method of claim 6, wherein the pre-set user interface views include a plurality of available interface color schemes.

10. The method of claim 6, wherein the customization data includes graphical element data corresponding to at least one graphical element selected for display on a user interface.
